(19) United States
(12) Patent Application Publication
(10) Pub. No.: US 2024/0146505 A1
(43) Pub. Date: May 2, 2024

(54) SECURE COMPUTATION SYSTEM, SECURE COMPUTATION SERVER APPARATUS, SECURE COMPUTATION METHOD, AND SECURE COMPUTATION PROGRAM

(71) Applicant: NEC Corporation, Minato-ku, Tokyo (JP)

(72) Inventor: Hikaru Tsuchida, Tokyo (JP)

(73) Assignee: NEC Corporation, Minato-ku, Tokyo (JP)

(21) Appl. No.: 18/272,733

(22) PCT Filed: Jan. 18, 2021
(86) PCT No.: PCT/JP2021/001468

§ 371 Date: Jul. 17, 2023

(51) Int. Cl. H04L 9/06

(52) U.S. Cl. CPC H04L 9/0631; H04L 2209/08

(57) ABSTRACT

An secure computation server apparatus in a secure computation system includes: a local shuffle part that computes, by using a shared permutation shared by four of the five secure computation server apparatuses, permuted values of a share for a remaining one of the five secure computation server apparatuses and sends the permuted values of the share to the remaining secure computation server apparatus; a comparison and verification part that compares values with each other, which are received from at least three of the four secure computation server apparatuses and which are supposed to be a same value, and adopts the values that are same at least two values as an accurate permutation; and a shuffle synthesis part that synthesizes mini-shuffles, by using a shared permutation shared by a corresponding combination of four secure computation server apparatuses and a permutation adopted by a corresponding one of the comparison and verification parts.

### TECHNICAL FIELD

The present invention relates to a secure computation system, a secure computation server apparatus, a secure computation method, and a secure computation program.

### BACKGROUND ART

In recent years, researches and developments on techniques referred to as secure computation are active. Secure computation is one of the techniques for executing predetermined processing while keeping its computation processes and the results thereof secret to third parties. One typical technique used for secure computation is a multiparty computation technique. In this multiparty computation technique, data that needs to be kept secret is distributed to a plurality of servers (secure computation server apparatuses), and each server performs various operations on the data distributed thereto while keeping the data secret. The data distributed to the individual secure computation server apparatuses is called “shares”. Hereinafter, unless otherwise stated, the term “secure computation” signifies the multiparty computation technique.

In the secure computation as described above, computation protocols for specific use are usually implemented in addition to four basic arithmetic operations. One example of these computation protocols for specific use is a shuffle protocol. If the shuffle protocol is used as one of the secure computation protocols, for example, sorting of the shares can be performed efficiently.

This sorting is a process of comparing the magnitudes of the values, which are kept secret as the shares, with each other and rearranging the shares based on the magnitude comparison result. The magnitude comparison result obtained in the sorting also needs to be kept secret. For example, information about the result of the comparison between the value of the share having a sequence number i and the value of the share having a sequence location j indirectly includes information about the values of the shares having the sequence numbers i and j. If this information is leaked, a security problem is caused. Thus, it is necessary to perform the sorting while keeping secret not only the values of the shares but also the magnitude comparison result. However, performing the computation while keeping the magnitude comparison result secret results in a poor efficiency (a large communication cost).

If a shuffle is performed before the sorting, the relationship between the sequence numbers and the values of the shares is lost. Thus, there is no need to keep the magnitude comparison result secret. In this way, since there is no need to keep the comparison result secret, the inefficient computation does not need to be performed, and the sorting efficiency is consequently improved. Therefore, implementing the shuffle protocol as one of the secure computation protocols is highly beneficial.

### CITATION LIST

### Non-Patent Literature

NPL 1: Byali, M., Chaudhari, H., Patra, A., & Suresh, A. (2020). FLASH: fast and robust framework for privacy-preserving machine learning. Proceedings on Privacy Enhancing Technologies, 2020(2), 459-480.

### SUMMARY

### Technical Problem

The disclosure of the above citation list is incorporated herein in its entirety by reference thereto. The following analysis has been made by the present inventor.

Different techniques that are generally referred to as secure computation achieve different security levels. For example, a case in which one of the participants in a multiparty secure computation is a dishonest person will be considered. In this case, it is possible to adopt a secure computation technique that can detect the presence of the dishonest person and can abort its processes. Alternatively, it is possible to adopt a secure computation technique that can obtain an accurate computation result without aborting its processes even if there is the dishonest person. The latter technique achieves a higher security than the former technique. The secure computation satisfying the latter security is referred to as Guaranteed Output Delivery (GOD), and an example of the secure computation realizing this GOD is known (for example, see NPL 1).

In addition, regarding the evaluation of the security in the secure computation, not only the advantageous effects of the security that can be achieved, but also pre-conditions have significant implications. A typical pre-condition is use of a random oracle model as a hash function.

A hash function is a function that responds a unique output to an input, and it is difficult to deduce the input from the output. However, although it is difficult to deduce the input from the output, there is no guarantee that the input cannot be deduced from the output. Thus, the security is evaluated on the assumption that the hash function used does not have vulnerability. The security based on this assumption is called “as being secure in the random oracle model”. The security of the secure computation in NPL 1 is “as being secure in the random oracle model”.

In contrast, there is an expression “as being secure in the standard model”, as opposed to “as being secure in the random oracle model”. That is, although the input could be deduced from the output of the hash function, if this itself does not mean vulnerability of the secure computation, the security is referred to “as being secure in the standard model”. Of course, if the same security level is achieved, the security of the standard model is higher than the security of the random oracle model. Thus, when the shuffle protocol is used, too, it is desirable to achieve Guaranteed Output Delivery (GOD) in the standard model.

The present invention has been made in view of the above problem, and it is an object of the present invention to provide a secure computation system, a secure computation server apparatus, a secure computation method, and a secure computation program that contribute to a bit conversion that achieves Guaranteed Output Delivery (GOD) in the standard model.

### Solution to Problem

According to a first aspect of the present invention, there is provided a secure computation system, which includes five secure computation server apparatuses connected to each other via a network, an individual one of the secure computation server apparatuses including: a local shuffle part that computes, by using a shared permutation shared by four of the five secure computation server apparatuses, permuted values of a share for a remaining one of the five secure computation server apparatuses and sends the permuted values of the share to the remaining secure computation server apparatus; a comparison and verification part that compares values with each other, which are received from at least three of the four secure computation server apparatuses and which are supposed to be a same value, and adopts the values that are same at least two values as an accurate permutation; and a shuffle synthesis part that synthesizes, regarding five combinations of four secure computation server apparatuses selected from the five secure computation server apparatuses, mini-shuffles, each of which is constructed by using a shared permutation shared by a corresponding combination of four secure computation server apparatuses and a permutation adopted by a corresponding one of the comparison and verification parts.

According to a second aspect of the present invention, there is provided a secure computation server apparatus, which is one of five secure computation server apparatuses connected to each other via a network, the secure computation server apparatus including: a local shuffle part that computes, by using a shared permutation shared by four of the five secure computation server apparatuses, permuted values of a share for a remaining one of the five secure computation server apparatuses and sends the permuted values of the share to the remaining secure computation server apparatus; a comparison and verification part that compares values with each other, which are received from at least three of the four secure computation server apparatuses and which are supposed to be a same value, and adopts the values that are same at least two values as an accurate permutation; and a shuffle synthesis part that synthesizes, regarding five combinations of four secure computation server apparatuses selected from the five secure computation server apparatuses, mini-shuffles, each of which is constructed by using a shared permutation shared by a corresponding combination of four secure computation server apparatuses and a permutation adopted by a corresponding one of the comparison and verification parts.

According to a third aspect of the present invention, there is provided a secure computation method, which uses five secure computation server apparatuses connected to each other via a network, the secure computation method including: causing an individual one of the secure computation server apparatuses to compute, by using a shared permutation shared by four of the five secure computation server apparatuses, permuted values of a share for a remaining one of the five secure computation server apparatuses; causing the individual one of the secure computation server apparatuses to send the permuted values of the share to the remaining secure computation server apparatus; causing the individual one of the secure computation server apparatuses to compare values with each other, which are received from at least three of the four secure computation server apparatuses and which are supposed to be a same value; causing the individual one of the secure computation server apparatuses to adopt the values that are same at least two values as an accurate permutation; and causing the individual one of the secure computation server apparatuses to synthesize, regarding five combinations of four secure computation server apparatuses selected from the five secure computation server apparatuses, mini-shuffles, each of which is constructed by using a shared permutation shared by a corresponding combination of four secure computation server apparatuses and a corresponding permutation adopted.

According to a fourth aspect of the present invention, there is provided a secure computation program, causing at least five secure computation server apparatuses connected to each other via a network to perform a secure computation, the program including: computing, by using a shared permutation shared by four of the five secure computation server apparatuses, permuted values of a share for a remaining one of the five secure computation server apparatuses; sending the permuted values of the share to the remaining secure computation server apparatus; comparing values with each other, which are received from at least three of the four secure computation server apparatuses and which are supposed to be a same value; adopting the values that are same at least two values as an accurate permutation; and synthesizing, regarding five combinations of four secure computation server apparatuses selected from the five secure computation server apparatuses, mini-shuffles, each of which is constructed by using a shared permutation shared by a corresponding combination of four secure computation server apparatuses and a corresponding permutation adopted. The program can be recorded in a computer-readable storage medium. The storage medium may be a non-transient storage medium such as a semiconductor memory, a hard disk, a magnetic recording medium, or an optical recording medium. The present invention can be embodied as a computer program product.

### Advantageous Effects of Invention

According to the individual aspects of the present invention, it is possible to provide a secure computation system, a secure computation server apparatus, a secure computation method, and a secure computation program that contribute to a bit conversion that achieves Guaranteed Output Delivery (GOD) in the standard model.

### BRIEF DESCRIPTION OF DRAWINGS

FIG. 1 is a block diagram illustrating a functional configuration example of a secure computation system according to a first example embodiment.

FIG. 2 is a block diagram illustrating a functional configuration example of a secure computation server apparatus according to the first example embodiment.

FIG. 3 is a flowchart illustrating an outline of a procedure of a secure computation method.

FIG. 4 is a block diagram illustrating a functional configuration example of a secure computation system according to a second example embodiment.

FIG. 5 is a block diagram illustrating a functional configuration example of a secure computation server apparatus according to the second example embodiment.

FIG. 6 is a diagram illustrating a hardware configuration example of a secure computation server apparatus.

### DESCRIPTION OF EMBODIMENTS

Hereinafter, example embodiments of the present invention will be described with reference to the accompanying drawings. However, the present invention is not limited to the following example embodiments. In addition, in the drawings, the same or equivalent elements are denoted by the same reference characters, as necessary. In addition, the drawings are schematic drawings, and therefore, it should be noted that the sizes, ratios, etc. of the individual elements may differ from their actual sizes, ratios, etc. An element in a drawing may have a portion whose size or ratio differs from that of the portion of the element in a different drawing.

### First Example Embodiment

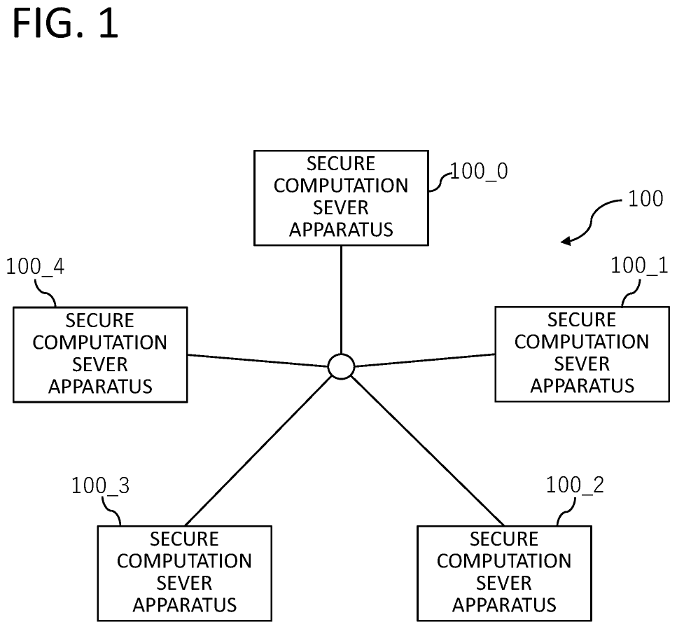

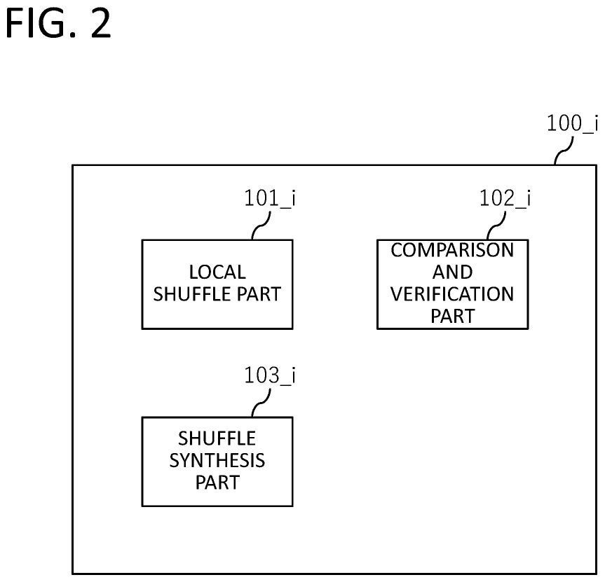

Hereinafter, a secure computation system and secure computation server apparatuses according to a first example embodiment will be described with reference to FIGS. 1 and 2. The first example embodiment is an example embodiment for describing only a basic concept of the present invention.

FIG. 1 is a block diagram illustrating a functional configuration example of a secure computation system according to the first example embodiment. As illustrated in FIG. 1, a secure computation system 100 according to the first example embodiment includes a first secure computation server apparatus 100_0, a second secure computation server apparatus 100_1, a third secure computation server apparatus 100_2, a fourth secure computation server apparatus 100_3, and a fifth secure computation server apparatus 100_4. The first secure computation server apparatus 100_0, the second secure computation server apparatus 100_1, the third secure computation server apparatus 100_2, the fourth secure computation server apparatus 100_3, and the fifth secure computation server apparatus 100_4 are connected to each other via a network such that these apparatuses can communicate with each other.

In the secure computation system 100 including the first to fifth secure computation server apparatuses 100_i (i=0, 1, 2, 3, 4), it is possible to compute target shares from a value inputted to any one of the first to fifth secure computation server apparatuses 100_i (i=0, 1, 2, 3, 4) while keeping the input value and the values acquired in the computation processes secret, and it is possible to dispersedly store the computation results in the first to fifth secure computation server apparatuses 100_i (i=0, 1, 2, 3, 4).

In addition, in the secure computation system 100 including the first to fifth secure computation server apparatuses 100_i (i=0, 1, 2, 3, 4), it is possible to compute target shares from the shares dispersedly stored in the first to fifth secure computation server apparatuses 100_i (i=0, 1, 2, 3, 4) while keeping the values in the computation processes secret, and it is possible to dispersedly store the computation results in the first to fifth secure computation server apparatuses 100_i (i=0, 1, 2, 3, 4).

The shares of the computation results may be reconstructed by causing the first to fifth secure computation server apparatuses 100_0 to 100_4 to exchange their shares with each other. Alternatively, the shares may be decoded by transmitting the shares to an external apparatus other than the first to fifth secure computation server apparatuses 100_0 to 100_4.

In addition, in the secure computation system 100 including the first to fifth secure computation server apparatuses 100_i (i=0, 1, 2, 3, 4), even when one of the first to fifth secure computation server apparatuses 100_i (i=0, 1, 2, 3, 4) is operated by a dishonest person, it is possible to continue an accurate secure computation without stopping the processes.

For example, the following construction may be adopted as the construction of the shares that enables continuation of an accurate secure computation without stopping the processes even when one of the first to fifth secure computation server apparatuses 100_i (i=0, 1, 2, 3, 4) is operated by a dishonest person as described above.

Shares of an element x of a residue class ring Zₙ of modulo n, that is, x∈Zₙ, on the residue class ring Zₙ are defined as follows (the shares may be referred to as arithmetic shares, as necessary). Note that n=2^{m}, where m is an integer of 2 or more. That is, a residue class ring Z₂ of modulo 2 is distinguished from the residue class ring Zₙ of modulo n.

An element x of the residue class ring Zₙ of modulo n, that is, x∈Zₙ, is decomposed to satisfy the following relationship:
x=x₀+x₁+x₂+x₃+x₄ mod n
[x]ᵢ dispersedly held by the individual participants Pᵢ, (i=0, 1, 2, 3, 4) is defined as follows.
[x]ᵢ=(xᵢ, xᵢ₊₁, xᵢ₊₂, xᵢ₊₃, note that x₄₊₁=x₀

Shares of an element x of the residue class ring Z₂ of modulo 2, that is, x∈Z₂, on the residue class ring Z₂ (the shares may be referred to as logic shares, as necessary) are defined in the same way as the above shares on the residue class ring Zₙ where n=2. However, a different notation [x]^{B} is used to distinguish the residue class ring Z₂ of modulo 2 from the residue class ring Zₙ of modulo n. That is, the shares are specifically defined as follows.

An element x of the residue class ring Z₂ of modulo 2, that is, x∈Z₂, is decomposed as follows. In Equation 1, “+” inside a circle represents an exclusive-or.

x=x₀⊕x₁⊕x₂⊕x₃⊕x₄ mod 2 [Equation 1]

[x]^{B}ᵢ dispersedly held by the individual participants Pᵢ, (i=0, 1, 2, 3, 4) is defined as follows.
[x]^{B}ᵢ=(xᵢ, xᵢ₊₁, xᵢ₊₂, xᵢ₊₃), note that x₄₊₁=x₀

If these shares [x]₀, [x]₁, [x]₂, [x]₃, and [x]₄ held by the individual participants Pᵢ, (i=0, 1, 2, 3, 4) are determined as described above, the individual participants Pᵢ, (i=0, 1, 2, 3, 4) cannot reconstruct x from their shares [x]₀, [x]₁, [x]₂, [x]₃, and [x]₄ held thereby. However, it is possible to realize secret sharing in which x can be reconstructed if the shares held by at least two of the participants Pᵢ (i=0, 1, 2, 3, 4) are combined. This secret sharing scheme is referred to as a 2-out-of-5 Replicated Secret Sharing Scheme.

Herein, a shuffle is used when a share sequence constructed as described above is dispersedly held by the individual participant. That is, an individual component xⱼ of a sequence having a sequence length M is decomposed into shares as follows, and the shares are dispersedly held by the individual participants Pᵢ (i=0, 1, 2, 3, 4).

\vec{x}=(x₀, . . . ,x₁, . . . ,x_{M-1})

xⱼ=x_{j,0}+x_{j,1}+x_{j,2}+x_{j,3}+x_{j,4} mod L

\vec{xᵢ}=(x_{0,i}, . . . ,x_{M-1,i})(i=0,1,2,3,4) [Equations 2]

In this secure computation based on the secret sharing scheme, not only when x is reconstructed but also when the locations in a sequence are shuffled, there is a situation in which the individual participants directly or indirectly receive the values of the sub-shares not held thereby from other participants. This is because it is necessary to shuffle the locations in a sequence while maintaining the values indicated by the shares held in a secret sharing manner by the individual participants. In addition, it is necessary that the values indicated by the shares be maintained even after the locations in the sequence are changed without letting the individual participants know the values indicated by their shares held thereby.

Thus, when a bit conversion is performed, too, there is a situation in which the individual participants also directly or indirectly receive the values of the sub-shares not held thereby from other participants. In this situation, if one of the other participants is a dishonest person, a participant could receive a different value instead of a value that the participant is originally supposed to receive. If this happens, the secure computation is performed based on an erroneous value, resulting in an erroneous result. In some cases, the computation itself cannot be performed properly.

To solve this problem, in the secure computation system 100 according to the present example embodiment, as illustrated in FIG. 2, an individual one of the first to fifth secure computation server apparatuses 100_i (i=0, 1, 2, 3, 4) includes a local shuffle part 101_i, a comparison and verification part 102_i, and a shuffle synthesis part 103_i. FIG. 2 is a block diagram illustrating a functional configuration example of a secure computation server apparatus according to the first example embodiment.

The local shuffle part 101_i computes, by using a shared permutation shared by four of the first to fifth secure computation server apparatuses 100_i (i=0, 1, 2, 3, 4), permuted values of a share for a remaining one of the first to fifth secure computation server apparatuses 100_i (i=0, 1, 2, 3, 4) and sends the permuted values of the share to the remaining secure computation server apparatus. The comparison and verification part 102_i compares the permuted values of the share with each other, which are received from at least three of the four secure computation server apparatuses and which are supposed to be the same value, and adopts the values that are same at least two values as an accurate permutation. The shuffle synthesis part 103_i synthesizes, regarding five combinations of four secure computation server apparatuses selected from the five secure computation server apparatuses 100_i (i=0, 1, 2, 3, 4), mini-shuffles, each of which is constructed by using a shared permutation shared by a corresponding combination of four secure computation server apparatuses and a permutation adopted by a corresponding one of the comparison and verification parts 102_i.

As described above, in the secure computation system 100 according to the present example embodiment, an individual one of the four of the first to fifth secure computation server apparatuses 100_i (i=0, 1, 2, 3, 4) permutes the locations of its sub-shares by using a permutation completed thereby and also performs a permutation for the remaining one of the secure computation server apparatuses. This remaining secure computation server apparatus receives the sub-shares permuted by the four secure computation server apparatuses from these four secure computation server apparatuses, compares the permuted values of the share, which are received from at least three of the four secure computation server apparatuses and which are supposed to be the same value, and adopts the values that are same at least two values as an accurate permutation. As a result, mini-shuffles are constructed in the first to fifth secure computation server apparatuses 100_i (i=0, 1, 2, 3, 4).

It should be noted here that, since each of the four secure computation server apparatuses completes a permutation by itself, each computation server apparatus knows how the locations in the share sequence have been permuted, and that because the remaining one of the secure computation server apparatuses receives a permuted result, this remaining secure computation server apparatus does not know how the locations in the share sequence have been permuted. Thus, regarding the five combinations of four secure computation server apparatuses selected from the first to fifth secure computation server apparatuses 100_i (i=0, 1, 2, 3, 4), if all the mini-shuffles constructed as described above are synthesized, a permutation (shuffle) that cannot be traced by any one of the first to fifth secure computation server apparatuses 100_i (i=0, 1, 2, 3, 4) can be constructed.

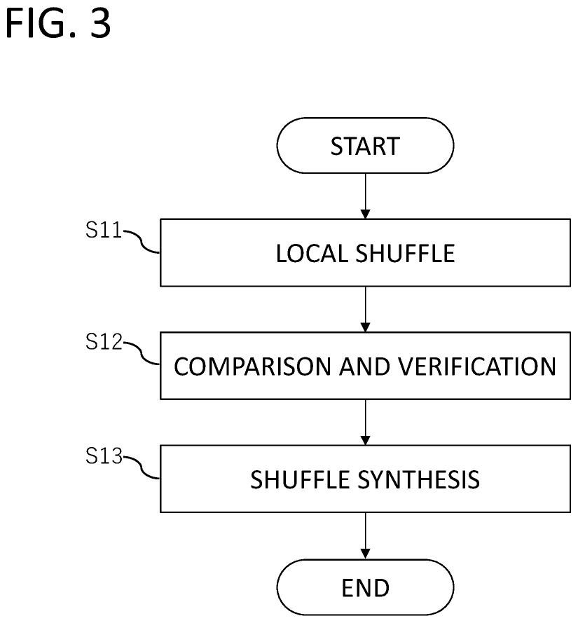

Next, a secure computation method according to the present example embodiment will be described. FIG. 3 is a flowchart illustrating an outline of a procedure of the secure computation method.

As illustrated in FIG. 3, the secure computation method according to the present example embodiment includes a local shuffle step (S11), a comparison and verification step (S12), and a shuffle synthesis step (S13). In the local shuffle step (S11), an individual secure computation server apparatus computes, by using a shared permutation shared by four of the first to fifth secure computation server apparatuses 100_i (i=0, 1, 2, 3, 4), permuted values of a share for a remaining one of the first to fifth secure computation server apparatuses 100_i (i=0, 1, 2, 3, 4) and sends the permuted values of the share to the remaining secure computation server apparatus. Next, in the comparison and verification step (S12), the individual secure computation server apparatus compares the permuted values of the share with each other, which are received from at least three of the four secure computation server apparatuses and which are supposed to be the same value, and adopts the values that are same at least two values as an accurate permutation. Finally, in the shuffle synthesis step (13), the individual secure computation server apparatus synthesizes, regarding five combinations of four secure computation server apparatuses selected from the five secure computation server apparatuses 100_i (i=0, 1, 2, 3, 4), mini-shuffles, each of which is constructed by using a shared permutation shared by a corresponding combination of four secure computation server apparatuses and a permutation adopted by a corresponding one of the comparison and verification parts 102_i.

As described above, in the secure computation system 100 and the secure computation method according to the present example embodiment, a participant receives received values, which are received from at least three of the other participants and which are supposed to be the same value, and adopts the received values that are same at least two received values as an accurate value. In this way, even if one of the other participants is a dishonest person, the participants can determine an accurate value. That is, even if there is a dishonest person, it is possible to realize Guaranteed Output Delivery (GOD) that can acquire an accurate computation without stopping the processes. In addition, because no hash function is used in the above processes, Guaranteed Output Delivery (GOD) is realized in a normal model.

The first example embodiment described above is an example embodiment for describing only a basic concept of the present invention. A second example embodiment described below is a practical example embodiment to which the above-described concept is applied.

### Second Example Embodiment

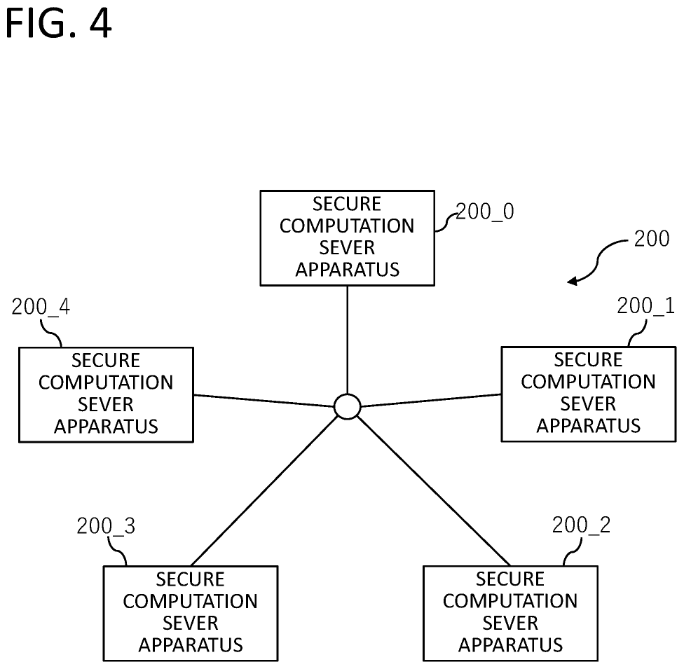

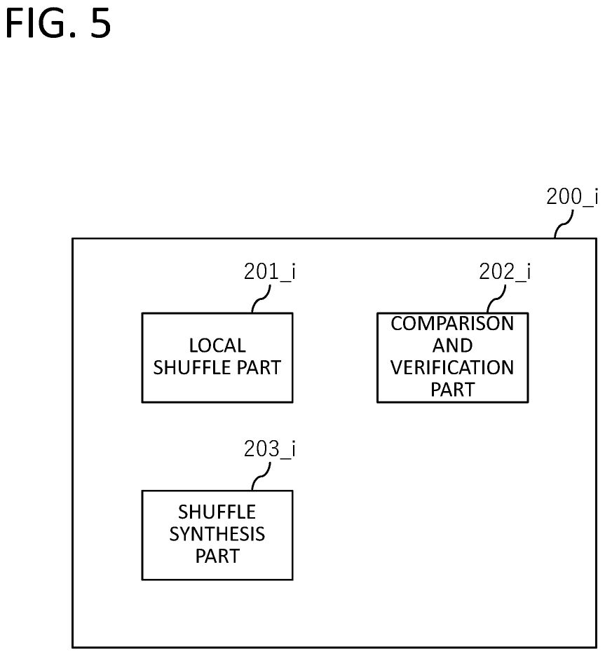

Hereinafter, a secure computation system and secure computation server apparatuses according to a second example embodiment will be described with reference to FIGS. 4 and 5.

FIG. 4 is a block diagram illustrating a functional configuration example of a secure computation system according to the second example embodiment. As illustrated in FIG. 4, a secure computation system 200 according to the second example embodiment includes a first secure computation server apparatus 200_0, a second secure computation server apparatus 200_1, a third secure computation server apparatus 200_2, a fourth secure computation server apparatus 200_3, and a fifth secure computation server apparatus 200_4. The first secure computation server apparatus 200_0, the second secure computation server apparatus 200_1, the third secure computation server apparatus 200_2, the fourth secure computation server apparatus 200_3, and the fifth secure computation server apparatus 200_4 are connected to each other via a network such that these apparatuses can communicate with each other.

In the secure computation system 200 including the first to fifth secure computation server apparatuses 200_i (i=0, 1, 2, 3, 4), it is possible to compute target shares from a value inputted to any one of the first to fifth secure computation server apparatuses 200_i (i=0, 1, 2, 3, 4) while keeping the input value and the values acquired in the computation processes secret, and it is possible to dispersedly store the computation results in the first to fifth secure computation server apparatuses 200_i (i=0, 1, 2, 3, 4).

In addition, in the secure computation system 200 including the first to fifth secure computation server apparatuses 200_i (i=0, 1, 2, 3, 4), even when one of the first to fifth secure computation server apparatuses 200_i (i=0, 1, 2, 3, 4) is operated by a dishonest person, it is possible to continue an accurate secure computation without stopping the processes.

FIG. 5 is a block diagram illustrating a functional configuration example of a secure computation server apparatus according to the second example embodiment. As illustrated in FIG. 5, in the secure computation system 200 according to the present example embodiment, an individual one of the first to fifth secure computation server apparatuses 200_i (i=0, 1, 2, 3, 4) includes a local shuffle part 201_i, a comparison and verification part 202_i, and a shuffle synthesis part 203_i.

The local shuffle part 201_i computes, by using a shared permutation shared by four of the first to fifth secure computation server apparatuses 200_i (i=0, 1, 2, 3, 4), permuted values of a share for a remaining one of the first to fifth secure computation server apparatuses 200_i (i=0, 1, 2, 3, 4) and sends the permuted values of the share to the remaining secure computation server apparatus. The comparison and verification part 202_i compares the permuted values of the share with each other, which are received from at least three of the four secure computation server apparatuses and which are supposed to be the same value, and adopts the values that are same at least two values as an accurate permutation. The shuffle synthesis part 203_i synthesizes, regarding five combinations of four secure computation server apparatuses selected from the five secure computation server apparatuses 200_i (i=0, 1, 2, 3, 4), mini-shuffles, each of which is constructed by using a shared permutation shared by a corresponding combination of four secure computation server apparatuses and a permutation adopted by a corresponding one of the comparison and verification parts 202_i.

Hereinafter, building blocks used for execution of the bit conversion according to the present example embodiment will be described.

[Generation of Pseudo Random Numbers and Sharing of Seeds] A pseudo-random function Fₙ, seeds, and an identifier have a relationship as follows. The pseudo-random function Fₙ, is a binary operation defined with a security parameter x.

Fₙ:{0,1}K^{k}×{0,1}^{k}→{0,1}ⁿ

Seeds seedᵢ ∈{0,1}^{k} ((i=0, 1, 2, 3, 4) are values appropriately shared by the individual secure computation server apparatuses 200_i, and an identifier vid ∈{0,1}^{k} is a public value such as a counter. The pseudo-random function Fₙ determinably generates pseudo random numbers by using the seeds and the identifier as its inputs.

Regarding the five seeds seedᵢ ∈{0,1}^{k} ((i=0, 1, 2, 3, 4), an individual one of the secure computation server apparatuses 200_i holds (seedᵢ, seedᵢ₊₁, seedᵢ₊₂, seedᵢ₊₃). Note that seed₄₊₁=seed₀. That is, an individual one of the secure computation server apparatuses 200_i holds the seeds seed, other than the seed seedᵢ₊₄. For example, the sharing of these seeds can be appropriately set by an administrator or the like as a presetting of the secure computation server apparatuses 200_i.

[Creation of Mask]

Next, a pseudo random number (Correlated Randomness) that is seen as a random number by the participant Pᵢ₊₄ and cannot be removed and that can be determinably computed by the other participants Pᵢ, Pᵢ₊₁, Pᵢ₊₂, and Pᵢ₊₃ is created, and this pseudo random number will be used as a mask when the permuted shares, which will be described below, are sent.

First, since the participant Pᵢ₊₄ does not hold the seed seedᵢ₊₃, if the seed seedᵢ₊₃ is used as an input of the pseudo-random function Fₙ, the following pseudo random number satisfies the above condition. That is, although the following rₖ is seen as a random number by the participant Pᵢ₊₄ and cannot be removed, the following rₖ can be determinably computed by the other participants Pᵢ, Pᵢ₊₁, Pᵢ₊₂, and Pᵢ₊₃. rₖ=Fₙ(vidₖ, seedᵢ₊₃)−Fₙ(vidₖ₊₁, seedᵢ₊₃) mod n

In addition, by changing the index k in the identifier vidₖ from k=0 to k=4, five pseudo random numbers rₖ can be created. A set of these pseudo random numbers rₖ is defined as follows. Whether the following pseudo random numbers r₀, r₁, r₂, r₃, and r₄ determined as follows satisfy r₀+r₁+r₂+r₃+r₄=0 can be easily determined.

(r₀,r₁,r₂,r₃,r₄)=CR(i+4,{vidₖ}⁴ₖ₌₀,seedᵢ₊₃)

Although the pseudo random numbers r₀, r₁, r₂, r₃, and r₄ created as described above are seen as random numbers by the participant Pᵢ₊₄ and cannot be removed, these pseudo random numbers can be determinably computed by the other participants Pᵢ, Pᵢ₊₁, Pᵢ₊₂, and Pᵢ₊₃. However, although the pseudo random numbers r₀, r₁, r₂, r₃, and r₄ cannot be removed by the participant Pᵢ₊₄, if all the pseudo random numbers r₀, r₁, r₂, r₃, and r₄ are collected, because the sum is 0, the pseudo random numbers r₀, r₁, r₂, r₃, and r₄ can be removed by the participant Pᵢ₊₄.

[Construction of Mini-Shuffles]

The construction of a mini-shuffle corresponds to the local shuffle step (S11) and the comparison and verification step (S12) described in the above first example embodiment.

The following description will be made on an example in which, among the participants Pᵢ (i=0, 1, 2, 3, 4), each of the participants Pᵢ (i=1, 2, 3, 4) computes a permutation of the participant P₀ for the participant P₀ by using a permutation shared thereby and sends the computed permutation to the participant P₀.

A permutation σ₀ ∈S_{M} shared by the participants Pᵢ (i=1, 2, 3, 4) is constructed as follows. As described above, the participants Pᵢ, (i=0, 1, 2, 3, 4) hold the seeds (seedᵢ, seedᵢ₊₁, seedᵢ₊₂, seedᵢ₊₃). In other words, each participant Pᵢ (i=0, 1, 2, 3, 4) does not hold the seed seedᵢ₊₄. That is, while the participant P₀ does not hold the seed seed₄, the other participants Pᵢ (i=1, 2, 3, 4) hold the seed seed₄ Thus, the permutation σ₀ ∈S_{M} shared by the participants Pᵢ (i=1, 2, 3, 4) is constituted by using a pseudo random number generated by using the seed seed₄. In this way, although the permutation σ₀ ∈S_{M} is traceable by the participants Pᵢ (i=1, 2, 3, 4), the permutation (To ∈S_{M} is not traceable by the participant P₀.

Next, by using the permutation σ₀ ∈S_{M} constructed as described above and the pseudo random number rₖ, each of the participants Pᵢ (i=1, 2, 3, 4) computes the permutation of the participant P₀ for the participant P₀ and sends the computed permutation to the participant P₀ as follows. It should be noted here that, from the method of constructing the shares in secret sharing, there are shares shared by the participants Pᵢ (i=1, 2, 3, 4) and the participant P₀ and that the participants Pᵢ (i=1, 2, 3, 4) can compute the permutation of the participant P₀ for the participant P₀.

{P₂,P₃,P₄}: \vec{r₀}+σ₀(\vec{x₀}) [Equations 3]

{P₁,P₃,P₄}: \vec{r₁}+σ₀(\vec{x₁})

{P₁,P₂,P₄}: \vec{r₂}+σ₀(\vec{x₂})

{P₁,P₂,P₃}:\vec{r₃}+σ₀(\vec{x₃})

xᵢ=(x_{0,i}, . . . ,x_{M-1,i})(i=0,1,2,3)

xⱼ=x_{j,0}+x_{j,1}+x_{j,2}+x_{j,3}+x_{j,4} mod L

rᵢ=(r_{i,0}, . . . ,r_{i,j}, . . . ,r_{i,m-1})

r_{0,j}+r_{1,j}+r_{2,j}+r_{3,j}+r_{4,j}=0 mod L(j=0, . . . ,m−1)

In the above transmission, note that the participants P₂, P₃, P₄ send the same value to the participant P₀, the participants P₁, P₃, P₄ send the same value to the participant P₀, the participants P₁, P₂, P₄ send the same value to the participant P₀, the participants P₁, P₂, P₃ send the same value to the participant P₀. From this nature, the participant P₀ can compare the values of the permuted shares, which are received from three participants and which are supposed to be the same value, and can adopt the received values that are same at least two received values as an accurate permutation. That is, even if one of the other participants is a dishonest person, the participants can determine an accurate value. That is, even if there is a dishonest person, it is possible to realize Guaranteed Output Delivery (GOD) that can acquire an accurate computation without stopping the processes.

In addition, in the above transmission, by using a hash function shared by the participants Pᵢ (i=1, 2, 3, 4) and transmitting the hash value as follows, the communication amount can be reduced. First, one of the three participants converts a value by using the hash function and sends the obtained hash value to the participant P₀. The other two participants send the value, not a hash value, to the participant P₀ without change. Upon receiving the value, the participant P₀ converts the value into a hash value by using the hash function. Next, the participant P₀ compares the hash values with each other. If at least two of the hash values are the same value, the participant P₀ adopts this value as an accurate value.

By performing the process as described above, a share corresponding to the permutation σ₀ ∈S_{M} that can be computed by the participants Pᵢ (i=1, 2, 3, 4) and that cannot be computed by the participant P₀ can be constituted as follows.

Pᵢ:[σ₀(\vec{x})]_{1,i}=(\vec{r₁}+σ₀(\vec{x₁}),\vec{rᵢ₊₁}+σ₀(\vec{xᵢ₊₁}),\vec{rᵢ₊₂}+σ₀(\vec{xᵢ₊₂}),\vec{rᵢ₊₃}σ₀(\vec{xᵢ₊₃}))

\vec{xᵢ}=(x_{0,i}, . . . ,x_{M-1,i})(i=0,1,2,3)

xⱼ=x_{j,0}+x_{j,1}+x_{j,2}+x_{j,3}+x_{j,4} mod L

r₁=(r_{i,0}, . . . ,r_{i,j}, . . . ,r_{i,m-1})

r_{0,j}+r_{1,j}+r_{2,j}+r_{3,j}+r_{4,j}=0 mod L(j=0, . . . ,m−1) [Equations 4]

[Synthesis of Mini-Shuffles]

In the above construction of mini-shuffles, of all the participants Pᵢ (i=0, 1, 2, 3, 4), each of the participants Pᵢ (i=1, 2, 3, 4) computes the permutation of the participant P₀ for the participant P₀ by using a permutation shared by the participants Pᵢ (i=1, 2, 3, 4) and sends the computed permutation to the participant P₀. However, alternatively, a combination of four participants Pᵢ and one participant P₀ may be changed. In this way, five mini-shuffles can be constructed. Each of these five mini-shuffles represents a permutation that is not traceable by one of the participants Pᵢ, (i=0, 1, 2, 3, 4).

Thus, by synthesizing all the permutations σᵢ (i=0, 1, 2, 3, 4)∈S_{M}, each of which is not traceable by one of the participants Pᵢ, (i=0, 1, 2, 3, 4), a permutation σ (shuffle) that is not traceable by any one of the participants Pᵢ (i=0, 1, 2, 3, 4) can be constructed.

σ=σ₀°σ₁°σ₂° σ₃°σ₄ [Equation 5]

Regarding the communication cost of the shuffle constructed as described above, the number of communication rounds is 5, and the communication amount is 40 nm bits. Regarding a single mini-shuffle, the number of communication rounds is 1, and the communication amount is 8 nm bits. Because five mini-shuffles are performed, the above communication cost is achieved.

### Hardware Configuration Example

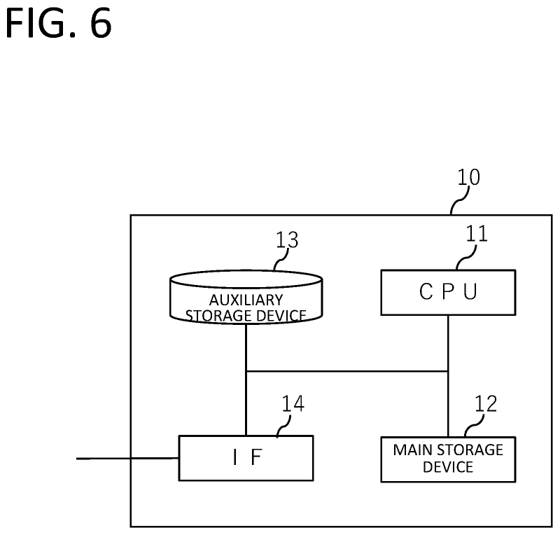

FIG. 6 is a diagram illustrating a hardware configuration example of a secure computation server apparatus. That is, the hardware configuration example illustrated in FIG. 6 is a hardware configuration example of any one of the secure computation server apparatuses 100_i and 200_i (i=0, 1, 2, 3, 4). An information processing apparatus (a computer) that adopts the hardware configuration illustrated in FIG. 6 can realize the individual functions of any one of the secure computation server apparatuses 100_i and 200_i (i=0, 1, 2, 3, 4) by executing the corresponding one of the above secure computation methods as a program.

The hardware configuration example illustrated in FIG. 6 is an example of the hardware configuration that realizes the individual functions of any one of the secure computation server apparatuses 100_i and 200_i (i=0, 1, 2, 3, 4), and does not limit the hardware configuration of any one of the secure computation server apparatuses 100_i and 200_i (i=0, 1, 2, 3, 4). The secure computation server apparatuses 100_i and 200_i (i=0, 1, 2, 3, 4) may include hardware not illustrated in FIG. 6.

As illustrated in FIG. 6, a hardware configuration 10 that can be adopted by any one of the secure computation server apparatuses 100_i and 200_i (i=0, 1, 2, 3, 4) includes, for example, a CPU (Central Processing Unit) 11, a main storage device 12, an auxiliary storage device 13, and an IF (Interface) part 14, which are connected to each other via an internal bus.

The CPU 11 executes various commands included in the secure computation program executed by the corresponding one of the secure computation server apparatuses 100_i and 200_i (i=0, 1, 2, 3, 4). The main storage device 12 is, for example, a RAM (Random Access Memory) and temporarily stores various kinds of programs such as the secure computation program executed by the corresponding one of the secure computation server apparatuses 100_i and 200_i (i=0, 1, 2, 3, 4) so that the CPU 11 can execute the programs.

The auxiliary storage device 13 is, for example, an HDD (Hard Disk Drive) and can store, in the mid-to-long term, various kinds of programs such as the secure computation program executed by the corresponding one of the secure computation server apparatuses 100_i and 200_i (i=0, 1, 2, 3, 4). These various kinds of programs such as the secure computation program can be recorded in a non-transitory computer-readable storage medium and can be provided as a program product. The auxiliary storage device 13 can be used to store, in the mid-to-long term, various kinds of programs such as the secure computation program recorded in a non-transitory computer-readable storage medium. The IF part 14 provides an interface regarding the input and output among the corresponding secure computation server apparatuses 100_i and 200_i (i=0, 1, 2, 3, 4).

An information processing apparatus that adopts the hardware configuration 10 as described above realizes the functions of any one of the secure computation server apparatuses 100_i and 200_i (i=0, 1, 2, 3, 4) by executing the corresponding one of the above-described secure computation methods as a program.

The above example embodiments can partially or entirely be described, but not limited to, as the following notes.

### [Note 1]

A secure computation system, which includes five secure computation server apparatuses connected to each other via a network, an individual one of the secure computation server apparatuses including:
a local shuffle part that computes, by using a shared permutation shared by four of the five secure computation server apparatuses, permuted values of a share for a remaining one of the five secure computation server apparatuses and sends the permuted values of the share to the remaining secure computation server apparatus;
a comparison and verification part that compares values with each other, which are received from at least three of the four secure computation server apparatuses and which are supposed to be a same value, and adopts the values that are same at least two values as an accurate permutation; and
a shuffle synthesis part that synthesizes, regarding five combinations of four secure computation server apparatuses selected from the five secure computation server apparatuses, mini-shuffles, each of which is constructed by using a shared permutation shared by a corresponding combination of four secure computation server apparatuses and a permutation adopted by a corresponding one of the comparison and verification parts.

### [Note 2]

The secure computation system according to note 1; wherein the mini-shuffles are each determinably generated by using seeds held by the four secure computation server apparatuses and an identifier held by the five secure computation server apparatuses as input and are each masked by pseudo random numbers whose total is zero regarding the five secure computation server apparatuses.

### [Note 3]

The secure computation system according to note 1 or 2; wherein the shared permutation is determinably generated by using a seed shared by the four secure computation server apparatuses as input.

### [Note 4]

The secure computation system according to any one of notes 1 to 3; wherein the comparison and verification part determines that the received values are each an accurate value by determining that hash values of the received values are same.

### [Note 5]

A secure computation server apparatus, which is one of five secure computation server apparatuses connected to each other via a network, the secure computation server apparatus including:
a local shuffle part that computes, by using a shared permutation shared by four of the five secure computation server apparatuses, permuted values of a share for a remaining one of the five secure computation server apparatuses and sends the permuted values of the share to the remaining secure computation server apparatus;
a comparison and verification part that compares values with each other, which are received from at least three of the four secure computation server apparatuses and which are supposed to be a same value, and adopts the values that are same at least two values as an accurate permutation; and
a shuffle synthesis part that synthesizes, regarding five combinations of four secure computation server apparatuses selected from the five secure computation server apparatuses, mini-shuffles, each of which is constructed by using a shared permutation shared by a corresponding combination of four secure computation server apparatuses and a permutation adopted by a corresponding one of the comparison and verification parts.

### [Note 6]

A secure computation method, which uses five secure computation server apparatuses connected to each other via a network, the secure computation method including:
causing an individual one of the secure computation server apparatuses to compute, by using a shared permutation shared by four of the five secure computation server apparatuses, permuted values of a share for a remaining one of the five secure computation server apparatuses;
causing the individual one of the secure computation server apparatuses to send the permuted values of the share to the remaining secure computation server apparatus;
causing the individual one of the secure computation server apparatuses to compare values with each other, which are received from at least three of the four secure computation server apparatuses and which are supposed to be a same value;
causing the individual one of the secure computation server apparatuses to adopt the values that are same at least two values as an accurate permutation; and
causing the individual one of the secure computation server apparatuses to synthesize, regarding five combinations of four secure computation server apparatuses selected from the five secure computation server apparatuses, mini-shuffles, each of which is constructed by using a shared permutation shared by a corresponding combination of four secure computation server apparatuses and a corresponding permutation adopted.

### [Note 7]

The secure computation method according to note 6; wherein the mini-shuffles are each determinably generated by using seeds held by the four secure computation server apparatuses and an identifier held by the five secure computation server apparatuses as input and are each masked by pseudo random numbers whose total is zero regarding the five secure computation server apparatuses.

### [Note 8]

The secure computation method according to note 6 or 7; wherein the shared permutation is determinably generated by using a seed shared by the four secure computation server apparatuses as input.

### [Note 9]

The secure computation method according to any one of notes 6 to 8; wherein it is determined that the permuted values of the share are each an accurate value by determining that hash values of the received values are same.

### [Note 10]

A secure computation program, causing at least five secure computation server apparatuses connected to each other via a network to perform a secure computation, the program including:
computing, by using a shared permutation shared by four of the five secure computation server apparatuses, permuted values of a share for a remaining one of the five secure computation server apparatuses;
sending the permuted values of the share to the remaining secure computation server apparatus;
comparing values with each other, which are received from at least three of the four secure computation server apparatuses and which are supposed to be a same value;
adopting the values that are same at least two values as an accurate permutation; and
synthesizing, regarding five combinations of four secure computation server apparatuses selected from the five secure computation server apparatuses, mini-shuffles, each of which is constructed by using a shared permutation shared by a corresponding combination of four secure computation server apparatuses and a corresponding permutation adopted.

The disclosure of the above NPL is incorporated herein by reference thereto. Modifications and adjustments of the example embodiments or examples are possible within the scope of the overall disclosure (including the claims) of the present invention and based on the basic technical concept of the present invention. Various combinations or selections (including partial deletion) of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed. In addition, as needed and based on the gist of the present invention, partial or entire use of the individual disclosed matters in the above literatures that have been referred to in combination with what is disclosed in the present application should be deemed to be included in what is disclosed in the present application, as a part of the disclosure of the present invention.

### REFERENCE SIGNS LIST

100, 200 secure computation system
100_i, 200_i secure computation server apparatus
101_i, 201_i local shuffle part
102_i, 202_i comparison and verification part
103_i, 203_i shuffle synthesis part
10 hardware configuration
11 CPU (Central Processing Unit)
12 main storage device
13 auxiliary storage device
14 IF (Interface) part

What is claimed is:

1. A secure computation system, which includes five secure computation server apparatuses connected to each other via a network, an individual one of the secure computation server apparatuses comprising:
a local shuffle part that computes, by using a shared permutation shared by four of the five secure computation server apparatuses, permuted values of a share for a remaining one of the five secure computation server apparatuses and sends the permuted values of the share to the remaining secure computation server apparatus;
a comparison and verification part that compares values with each other, which are received from at least three of the four secure computation server apparatuses and which are supposed to be a same value, and adopts the values that are same at least two values as an accurate permutation; and
a shuffle synthesis part that synthesizes, regarding five combinations of four secure computation server apparatuses selected from the five secure computation server apparatuses, mini-shuffles, each of which is constructed by using a shared permutation shared by a corresponding combination of four secure computation server apparatuses and a permutation adopted by a corresponding one of the comparison and verification parts.

2. The secure computation system according to claim 1; wherein the mini-shuffles are each determinably generated by using seeds held by the four secure computation server apparatuses and an identifier held by the five secure computation server apparatuses as input and are each masked by pseudo random numbers whose total is zero regarding the five secure computation server apparatuses.

3. The secure computation system according to claim 1; wherein the shared permutation is determinably generated by using a seed shared by the four secure computation server apparatuses as input.

4. The secure computation system according to claim 1; wherein the comparison and verification part determines that the received values are each an accurate value by determining that hash values of the received values are same.

5. A secure computation server apparatus, which is one of five secure computation server apparatuses connected to each other via a network, the secure computation server apparatus comprising:
a local shuffle part that computes, by using a shared permutation shared by four of the five secure computation server apparatuses, permuted values of a share for a remaining one of the five secure computation server apparatuses and sends the permuted values of the share to the remaining secure computation server apparatus;
a comparison and verification part that compares values with each other, which are received from at least three of the four secure computation server apparatuses and which are supposed to be a same value, and adopts the values that are same at least two values as an accurate permutation; and
a shuffle synthesis part that synthesizes, regarding five combinations of four secure computation server apparatuses selected from the five secure computation server apparatuses, mini-shuffles, each of which is constructed by using a shared permutation shared by a corresponding combination of four secure computation server apparatuses and a permutation adopted by a corresponding one of the comparison and verification parts.

6. A secure computation method, which uses five secure computation server apparatuses connected to each other via a network, the secure computation method comprising:
causing an individual one of the secure computation server apparatuses to compute, by using a shared permutation shared by four of the five secure computation server apparatuses, permuted values of a share for a remaining one of the five secure computation server apparatuses;
causing the individual one of the secure computation server apparatuses to send the permuted values of the share to the remaining secure computation server apparatus;
causing the individual one of the secure computation server apparatuses to compare values with each other, which are received from at least three of the four secure computation server apparatuses and which are supposed to be a same value;
causing the individual one of the secure computation server apparatuses to adopt the values that are same at least two values as an accurate permutation; and
causing the individual one of the secure computation server apparatuses to synthesize, regarding five combinations of four secure computation server apparatuses selected from the five secure computation server apparatuses, mini-shuffles, each of which is constructed by using a shared permutation shared by a corresponding combination of four secure computation server apparatuses and a corresponding permutation adopted.

7. The secure computation method according to claim 6; wherein the mini-shuffles are each determinably generated by using seeds held by the four secure computation server apparatuses and an identifier held by the five secure computation server apparatuses as input and are each masked by pseudo random numbers whose total is zero regarding the five secure computation server apparatuses.

8. The secure computation method according to claim 6; wherein the shared permutation is determinably generated by using a seed shared by the four secure computation server apparatuses as input.

9. The secure computation method according to claim 6; wherein it is determined that the permuted values of the share are each an accurate value by determining that hash values of the received values are same.

10. A non-transient computer readable medium storing a secure computation program, causing at least five secure computation server apparatuses connected to each other via a network to perform a secure computation, the program comprising:
computing, by using a shared permutation shared by four of the five secure computation server apparatuses, permuted values of a share for a remaining one of the five secure computation server apparatuses;
sending the permuted values of the share to the remaining secure computation server apparatus;
comparing values with each other, which are received from at least three of the four secure computation server apparatuses and which are supposed to be a same value;
adopting the values that are same at least two values as an accurate permutation; and
synthesizing, regarding five combinations of four secure computation server apparatuses selected from the five secure computation server apparatuses, mini-shuffles, each of which is constructed by using a shared permutation shared by a corresponding combination of four secure computation server apparatuses and a corresponding permutation adopted.

11. The secure computation server apparatus according to claim 5; wherein the mini-shuffles are each determinably generated by using seeds held by the four secure computation server apparatuses and an identifier held by the five secure computation server apparatuses as input and are each masked by pseudo random numbers whose total is zero regarding the five secure computation server apparatuses.

12. The secure computation server apparatus according to claim 5; wherein the shared permutation is determinably generated by using a seed shared by the four secure computation server apparatuses as input.

13. The secure computation server apparatus according to claim 5; wherein the comparison and verification part determines that the received values are each an accurate value by determining that hash values of the received values are same.

14. The non-transient computer readable medium storing the secure computation program according to claim 10; wherein the mini-shuffles are each determinably generated by using seeds held by the four secure computation server apparatuses and an identifier held by the five secure computation server apparatuses as input and are each masked by pseudo random numbers whose total is zero regarding the five secure computation server apparatuses.

15. The non-transient computer readable medium storing the secure computation program according to claim 10; wherein the shared permutation is determinably generated by using a seed shared by the four secure computation server apparatuses as input.

16. The non-transient computer readable medium storing the secure computation program according to claim 10; wherein it is determined that the permuted values of the share are each an accurate value by determining that hash values of the received values are same.
